(19) United States
(12) Patent Application Publication
(10) Pub. No.: US 2008/0255279 A1
(43) Pub. Date: Oct. 16, 2008

(54) Flameproof Molding Compounding

(76) Inventors: Ralf Neuhaus, Heidelberg (DE); Klaus Uske, Bad Durkheim (DE)

Correspondence Address: CONNOLLY BOVE LODGE & HUTZ, LLP, P O BOX 2207, WILMINGTON, DE, 19899, US

(21) Appl. No.: 12/090,098

(22) PCT Filed: Oct. 5, 2006
(86) PCT No.: PCT/EP06/67060

§ 371 Date: Apr. 14, 2008

(30) Foreign Application Priority Data
Oct. 12, 2005 (DE) 10 2005 049 297.5

(51) Int. Cl. C08K 5/3492; C08K 3/02

(52) U.S. Cl. 524/100; 524/80

(57) ABSTRACT

Thermoplastic molding compositions, comprising

A) from 10 to 99.4% by weight of at least one thermoplastic polyamide
B) from 0.5 to 20% by weight of a melamine compound
C) from 0.1 to 60% by weight of red phosphorus
D) from 0 to 60% by weight of other additives,
where the total of the percentages by weight of A) to D) is 100%.

The invention relates to thermoplastic molding compositions, comprising

A) from 10 to 99.4% by weight of at least one thermoplastic polyamide
B) from 0.5 to 20% by weight of a melamine compound
C) from 0.1 to 60% by weight of red phosphorus
D) from 0 to 60% by weight of other additives,
where the total of the percentages by weight of A) to D) is 100%.

The invention further relates to the use of the inventive molding compositions for production of fibers, of foils, and of moldings, and also to the resultant moldings. When red phosphorus is incorporated into polymer melts, industrial safety problems arise due to dusting and phosphine evolution.

DE-A 27 03 052, DE-A 196 48 503, EP-A 071 788, EP-A-176 836, and EP-A 384 232 disclose various flame-retardant PA molding compositions which comprise red phosphorus.

A new issue of the IEC 60335 standard for appliances is introducing from 2006 increased stringency of requirements in fire tests for unattended household appliances whose operating current is >0.2 A. Tests apply to all plastics parts in contact with electrical conductors having this magnitude of current. These components are generally produced via injection molding from thermoplastics. The standard prescribes that the component must pass the glow-wire test (GWT to IEC 60695-2-11) at 750° C., and total burn times greater than two seconds here lead to additional complicated measures in appliance manufacture and appliance approval. A pass in the GWT glow-wire test requires that at 750° C. the total burn time, which is a measure of flame retardancy, is <=2 seconds (abbreviated to: GWT 750<=2 s).

However, when polyamide molding compositions are used currently the materials have to comprise halogen in order to provide sufficiently reliable compliance with the “GWT 750<=2 s” requirement. However, halogen-containing compounded materials have a number of disadvantages, e.g. high density, high smoke toxicity, high smoke density, and low CTI, and it is therefore desirable to find a halogen-free alternative for these applications. Clearly, polyamide molding compositions using red phosphorus as flame retardant can be used here. Unfortunately, these compositions exhibit only an inadequate level of reproducibility in passing the GWT 750<=2 s glow-wire test, and this is moreover also very greatly dependent on the geometry of the component.

It was therefore an object of the present invention to provide flame-retardant PA molding compositions which perform better in the glow-wire test and comply with the abovementioned standard. At the same time, very substantial retention of mechanical properties is intended.

Accordingly, the flame-retardant molding compositions defined at the outset have been found. Preferred molding compositions of this type and their use are given in the subclaims.

The inventive molding compositions comprise, as component A), from 10 to 99.4%, preferably from 20 to 98%, and in particular from 20 to 95% by weight, of at least one polyamide.

The polyamides of the inventive molding compositions generally have a viscosity number of from 90 to 350 ml/g, preferably from 110 to 240 ml/g, determined in a 0.5% strength by weight solution in 96% strength by weight sulfuric acid at 25° C. to ISO 307.

Semicrystalline or amorphous resins with a molecular weight (weight-average) of at least 5000, e.g. those described in the American patent specifications 2 071 250, 2 071 251, 2 130 523, 2 130 948, 2 241 322, 2 312 966, 2 512 606 and 3 393 210, are preferred.

Examples of these are polyamides derived from lactams having from 7 to 13 ring members, e.g. polycaprolactam, polycaprylolactam, and polylaurolactam, and also polyamides obtained via reaction of dicarboxylic acids with diamines.

Dicarboxylic acids which may be used are alkanedicarboxylic acids having from 6 to 12, in particular from 6 to 10, carbon atoms, and aromatic dicarboxylic acids. Acids which may be mentioned here merely as examples are adipic acid, azelaic acid, sebacic acid, dodecanedioic acid and terephthalic and/or isophthalic acid.

Particularly suitable diamines are alkanediamines having from 6 to 12, in particular from 6 to 8, carbon atoms, and also m-xylylenediamine, di(4-aminophenyl)methane, di(4-aminocyclohexyl)methane, 2,2-di(4-aminophenyl)propane, 2,2-di(4-aminocyclohexyl)propane or 1,5-diamino-2-methylpentane.

Preferred polyamides are polyhexamethyleneadipamide, polyhexamethylenesebacamide and polycaprolactam, and also nylon-6/6,6 copolyamides, in particular having a proportion of from 5 to 95% by weight of caprolactam units.

Other suitable polyamides are obtainable from ω-aminoalkyl nitrites, e.g. aminocapronitrile (PA 6) and adipodinitrile with hexamethylenediamine (PA 66) via what is known as direct polymerization in the presence of water, for example as described in DE-A 10313681, EP-A 1198491 and EP 922065.

Mention may also be made of polyamides obtainable, by way of example, via condensation of 1,4-diaminobutane with adipic acid at an elevated temperature (nylon-4,6). Preparation processes for polyamides of this structure are described by way of example in EP-A 38 094, EP-A 38 582, and EP-A 39 524.

Other suitable examples are polyamides obtainable via copolymerization of two or more of the abovementioned monomers, and mixtures of two or more polyamides in any desired mixing ratio.

Other polyamides which have proven particularly advantageous are semiaromatic copolyamides, such as PA 6/6T and PA 66/6T, where the triamine content of these is less than 0.5% by weight, preferably less than 0.3% by weight (see EP-A 299 444).

The processes described in EP-A 129 195 and 129 196 can be used to prepare the preferred semiaromatic copolyamides with low triamine content.

The following list, which is not comprehensive, comprises the polyamides A) mentioned and other polyamides A) for the purposes of the invention, and the monomers present:

| | |
|---|---|
| AB polymers: | |
| PA 4 | Pyrrolidone |
| PA 6 | ε-Caprolactam |
| PA 7 | Ethanolactam |
| PA 8 | Caprylolactam |
| PA 9 | 9-Aminopelargonic acid |
| PA 11 | 11-Aminoundecanoic acid |
| PA 12 | Laurolactam |
| AA/BB polymers: | |
| PA 46 | Tetramethylenediamine, adipic acid |
| PA 66 | Hexamethylenediamine, adipic acid |
| PA 69 | Hexamethylenediamine, azelaic acid |
| PA 610 | Hexamethylenediamine, sebacic acid |
| PA 612 | Hexamethylenediamine, decaneciicarboxylic acid |
| PA 613 | Hexamethylenediamine, undecanedicarboxylic acid |
| PA 1212 | 1,12-Dodecanediamine, decanedicarboxylic acid |
| PA 1313 | 1,13-Diaminotridecane, undecanedicarboxylic acid |
| PA 6T | Hexamethylenediamine, terephthalic acid |
| PA MXD6 | m-Xylylenediamine, adipic acid |
| AA/BB polymers: | |
| PA 6I | Hexamethylenediamine, isophthalic acid |
| PA 6-3-T | Trimethylhexamethylenediamine, terephthalic acid |
| PA 6/6T | (see PA 6 and PA 6T) |
| PA 6/66 | (see PA 6 and PA 66) |
| PA 6/12 | (see PA 6 and PA 12) |
| PA 66/6/610 | (see PA 66, PA 6 and PA 610). |
| PA 6I/6T | (see PA 6I and PA 6T) |
| PA PACM 12 | Diaminodicyclohexylmethane, laurolactam |
| PA 6I/6T/PACM | as PA 6I/6T + diaminodicyclohexylmethane |
| PA 12/MACMI | Laurolactam, dimethyldiaminodicyclohexylmethane, |
| | isophthalic acid |
| PA 12/MACMT | Laurolactam, dimethyldiaminodicyclohexylmethane, |
| | terephthalic acid |
| PA PDA-T | Phenylenediamine, terephthalic acid |

Other monomers that can be used are cyclic diamines such as those of the general formula

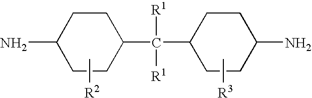

where
R¹ is hydrogen or a C₁-C₄-alkyl group,
R² is a C₁-C₄-alkyl group or hydrogen, and
R³ is a C₁-C₄-alkyl group or hydrogen.

Particularly preferred diamines are bis(4-aminocyclohexyl)methane, bis(4-amino-3-methylcyclohexyl)methane, 2,2-bis(4-aminocyclohexyl)propane, or 2,2-bis(4-amino-3-methylcyclohexyl)propane.

Other diamines which may be mentioned are 1,3- or 1,4-cyclohexanediamine or isophoronediamine.

It is also possible to use a mixture of above polyamides.

The inventive thermoplastic molding compositions comprise, as component B), from 0.5 to 20% by weight, preferably from 0.5 to 10% by weight, and in particular from 1 to 8% by weight, of a melamine compound.

The melamine cyanurate preferably suitable (component B) according to the invention is a reaction product of preferably equimolar amounts of melamine (formula II) and cyanuric acid or isocyanuric acid (formulae IIa and IIb)

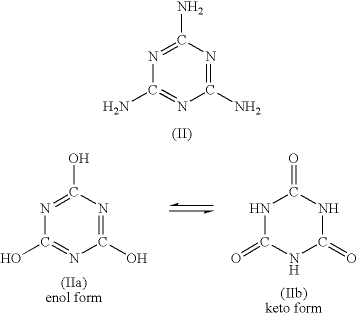

It is obtained by way of example via reaction of aqueous solutions of the starting compounds at from 90 to 100° C. The product available commercially is a white powder whose d₅₀ average grain size is from 1.5 to 7 μm.

Other suitable compounds (also often termed salts or adducts) are melamine, melamine borate, melamine oxalate, melamine phosphate (prim.), melamine phosphate (sec.), and melamine pyrophosphate (sec.), melamine neopentyl glycol borate, and polymeric melamine phosphate (CAS No. 56386-64-2).

Particularly preferred melamine polyphosphate is obtainable from Ciba Speciality Chem. with the trademark Melapur®. Preferred phosphorus content is from 10 to 15%, in particular from 12 to 14%, and water content is preferably below 0.3%, density being from 1.83 to 1.86 g/cm³.

Preferred flame retardant C) is elemental red phosphorus, in particular in combination with glass fiber-reinforced molding compositions; it can be used in untreated form.

However, preparations that are particularly suitable are those in which the phosphorus has been surface-coated with low-molecular-weight liquids, such as silicone oil, paraffin oil, or esters of phthalic acid or adipic acid, or with polymeric or oligomeric compounds, e.g. with phenolic resins or with aminoplastics, or else with polyurethanes.

Concentrates of red phosphorus, e.g. in a polyamide or elastomer, are also suitable as flame retardant. Particularly suitable concentrate polymers are homo- and copolyolefins. However—if no polyamide is used as thermoplastic—the content of the concentrate polymer should not be more than 35% by weight, based on the weight of components A) and B) in the inventive molding compositions.

Preferred concentrate constitutions are
C₁) from 30 to 90% by weight, preferably from 50 to 70% by weight, of a polyamide.
C₂) from 10 to 70% by weight, preferably from 30 to 50% by weight, of red phosphorus.

The polyamide used for the masterbatch can differ from A) or preferably can be identical with A), in order that incompatibility or melting-point differences do not have any adverse effect on the molding composition.

The average particle size (d₅₀) of the phosphorus particles distributed in the molding compositions is preferably in the range from 0.0001 to 0.5 mm; in particular from 0.001 to 0.2 mm.

The content of component B) in the inventive molding compositions is from 1 to 30% by weight, preferably from 2 to 20% by weight, and in particular from 2 to 10% by weight, based on the entirety of components A) to C).

The inventive molding compositions can comprise, as component D), from 0 to 60% by weight, in particular up to 50% by weight, of other additives and processing aids.

Examples of amounts of other usual additives D1) are up to 40% by weight, preferably from 1 to 40% by weight, of elastomeric polymers (also often termed impact modifiers, elastomers, or rubbers).

These are very generally copolymers which have preferably been built up from at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der or ganischen Chemie, Vol. 14/1 (Georg-Thieme-Verlag, Stuttgart, Germany, 1961), pages 392-406, and in the monograph by C. B. Bucknall, “Toughened Plastics” (Applied Science Publishers, London, UK, 1977).

Some preferred types of such elastomers are described below.

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenyinorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo[5.2.1.0^{2.6}]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These monomers comprising dicarboxylic acid derivatives or comprising epoxy groups are preferably incorporated into the rubber by adding to the monomer mixture monomers comprising dicarboxylic acid groups and/or epoxy groups and having the general formulae I, II, III or IV.

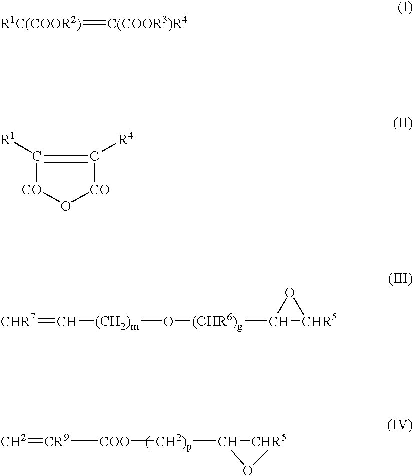

where R¹ to R⁹ are hydrogen or alkyl groups having from 1 to 6 carbon atoms, and m is a whole number from 0 to 20, g is a whole number from 0 to 10 and p is a whole number from 0 to 5.

R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising anhydride groups, the remaining amount being (meth)acrylates.

Particular preference is given to copolymers composed of

from 50 to 98.9% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particular from 5 to 40% by weight, of n-butyl acrylate and/or 2-ethylhexyl acrylate.

Other preferred (meth)acrylates are the methyl, ethyl, propyl, isobutyl and tert-butyl esters.

Besides these, comonomers which may be used are vinyl esters and vinyl ethers.

The ethylene copolymers described above may be prepared by processes known per se, preferably by random copolymerization at high pressure and elevated temperature. Appropriate processes are well-known.

Other preferred elastomers are emulsion polymers whose preparation is described, for example, by Blackley in the monograph “Emulsion Polymerization”. The emulsifiers and catalysts which can be used are known per se.

In principle it is possible to use homogeneously structured elastomers or else those with a shell structure. The shell-type structure is determined by the sequence of addition of the individual monomers. The morphology of the polymers is also affected by this sequence of addition.

Monomers which may be mentioned here, merely as examples, for the preparation of the rubber fraction of the elastomers are acrylates, such as n-butyl acrylate and 2-ethylhexyl acrylate, corresponding methacrylates, butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells), Elastomers having more than one shell may also have more than one shell composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible to use relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

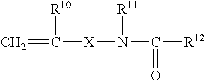

where the substituents can be defined as follows:
R¹⁰ is hydrogen or a C₁-C₄-alkyl group,
R¹¹ is hydrogen, a C₁-C₁₈-alkyl group or an aryl group, in particular phenyl,
R¹² is hydrogen, a C₁-C₁₀-alkyl group, a C₆-C₁₂-aryl group, or —OR¹³,
R¹³ is a C₁-C₈-alkyl group or a C₆-C₁₂-aryl group, which can optionally have substitution by groups that comprise O or by groups that comprise N.
X is a chemical bond, a C₁-C₁₀-alkylene group, or a C₆-C₁₂-arylene group, or

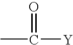

Y is O-Z or NH-Z, and
Z is a C₁-C₁₀-alkylene or C₆-C₁₂-arylene group.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, n-butyl acrylate, | styrene, acrylonitrile, methyl |
| | ethylhexyl acrylate, or a mixture of | methacrylate |
| | these | |
| II | as I, but with concomitant use of | as I |
| | crosslinking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but with concomitant use |
| | | of monomers having reactive |
| | | groups, as described herein |
| V | styrene, acrylonitrile, methyl methacrylate, | first envelope composed of monomers |
| | or a mixture of these | as described under I and II for |
| | | the core, second envelope as described |
| | | under I or IV for the envelope |

Instead of graft polymers whose structure has more than one shell, it is also possible to use homogeneous, i.e. single-shell, elastomers composed of 1,3-butadiene, isoprene and n-butyl acrylate or of copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate-glycidyl acrylate or n-butyl acrylate-glycidyl methacrylate copolymers, graft polymers with an inner core composed of n-butyl acrylate or based on butadiene and with an outer envelope composed of the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603 and EP-A 319 290.

It is, of course, also possible to use mixtures of the types of rubber listed above.

Fibrous or particulate fillers D) which may be mentioned are carbon fibers, glass fibers, glass beads, amorphous silica, calcium silicate, calcium metasilicate, magnesium carbonate, kaolin, chalk, powdered quartz, mica, barium sulfate and feldspar, used in amounts of up to 50% by weight, in particular from 1 to 40% by weight, preferably from 10 to 30% by weight.

Preferred fibrous fillers which may be mentioned are carbon fibers, aramid fibers and potassium titanate fibers, and particular preference is given to glass fibers in the form of E glass. These may be used as rovings or in the commercially available forms of chopped glass.

The fibrous fillers may have been surface-pretreated with a silane compound to improve compatibility with the thermoplastic.

Suitable silane compounds have the general formula:

(X—(CH₂)ₙ)ₖ—Si—(O—CₘH₂ₘ₊₁)₄₋ₖ

where:

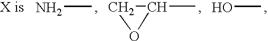

n is a whole number from 2 to 11, preferably 3 to 4,
m is a whole number from 1 to 5, preferably 1 to 2, and
k is a whole number from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group as substituent X.

The amounts of the silane compounds generally used for surface-coating are from 0.01 to 2% by weight, preferably from 0.025 to 1.0% by weight and in particular from 0.05 to 0.5% by weight (based on C).

Acicular mineral fillers are also suitable.

For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may, if appropriate, have been pretreated with the abovementioned silane compounds, but the pretreatment is not essential.

Other fillers which may be mentioned are kaolin, calcined kaolin, wollastonite, talc and chalk, and also lamellar or acicular nanofillers, the amounts of these preferably being from 0.1 to 10%. Materials preferred for this purpose are boehmite, bentonite, montmorillonite, vermiculite, hectorite, and laponite. The lamellar nanofillers are organically modified by prior-art methods, to give them good compatibility with the organic binder. Addition of the lamellar or acicular nanofillers to the inventive nanocomposites gives a further increase in mechanical strength.

As component D), the thermoplastic molding compositions of the invention may comprise usual processing aids, such as stabilizers, oxidation retarders, agents to counteract decomposition due to heat and decomposition due to ultraviolet light, lubricants and mold-release agents, colorants, such as dyes and pigments, nucleating agents, plasticizers, flame retardants, etc.

Examples which may be mentioned of oxidation retarders and heat stabilizers are sterically hindered phenols and/or phosphites and amines (e.g. TAD), hydroquinones, aromatic secondary amines, such as diphenylamines, various substituted members of these groups, and mixtures of these in concentrations of up to 1% by weight, based on the weight of the thermoplastic molding compositions.

UV stabilizers which may be mentioned, and are generally used in amounts of up to 2% by weight, based on the molding composition, are various substituted resorcinols, salicylates, benzotriazoles, and benzophenones.

Preferred stabilizers are zinc compounds, such as ZnO, or inorganic or organic compounds of a di- or tetravalent metal, such as cadmium, zinc, aluminum tin [see EP-A-92776], the amounts that can be used of these being up to 0.005-8, preferably up to 0.05-3, % by weight.

Colorants which may be added are inorganic pigments, such as titanium dioxide, ultramarine blue, iron oxide, and carbon black, and also organic pigments, such as phthalocyanines, quinacridones and perylenes, and also dyes, such as nigrosine and anthraquinones.

Nucleating agents which may be used are sodium phenylphosphinate, alumina, silica, and preferably talc.

The inventive thermoplastic molding compositions may be prepared by methods known per se, by mixing the starting components in conventional mixing apparatus, such as screw extruders, Brabender mixers or Banbury mixers, and then extruding them. The extrudate may then be cooled and comminuted. It is also possible to premix individual components and then to add the remaining starting materials individually and/or likewise in a mixture. The mixing temperatures are generally from 230 to 320° C.

In another preferred procedure, components B) and C), and also, if appropriate, D) can be mixed with a prepolymer, compounded, and pelletized. The resultant pellets are then solid-phase condensed under an inert gas, continuously or batchwise, at a temperature below the melting point of component A) until the desired viscosity has been reached.

The inventive thermoplastic molding compositions feature a good glow-wire test result together with good mechanical properties.

These materials are suitable for production of fibers, foils, and moldings of any type.

Some examples are now given: cylinder-head covers, motorcycle covers, inlet manifoids, charge-air cooler caps, plug connectors, gearwheels, cooling-fan wheels, cooling-water tanks, plugs, plug parts, cable-harness components, circuit mounts, circuit-mount components, three-dimensionally injection-molded circuit mounts, electrical connector elements, and mechatronic components.

Possible automobile interior uses are those for dashboards, steering-column switches, seat components, headrests, center consoles, gearbox components and door modules, and possible automobile exterior uses are those for door handles, exterior-mirror components, windshield-wiper components, windshield-wiper protective housings, grilles, roof rails, sunroof frames, engine covers, cylinder-head covers, inlet manifolds, windshield wipers, and exterior bodywork parts.

Possible uses of improved-flow polyamides in the kitchen and household sector are those for production of components for kitchen equipment, e.g. fryers, smoothing irons, and buttons, and also applications in the garden and leisure sectors, e.g. components for irrigation systems, or garden equipment and door handles.

### EXAMPLES

The following components were used:

### Component A:

Nylon-6,6 whose viscosity number V/N is 150 ml/g, measured in the form of a 0.5% strength by weight solution in 96% strength by weight sulfuric acid at 25° C. to ISO 307 (the material used being Ultramid® A3 from BASF AG).

### Component B)

melamine polyphosphate

### Component Ca)

red phosphorus

Component Cb) masterbatch composed of
C₁) PA 66 (see component A), 60% by weight
C₂) red phosphorus, 40% by weight

### Component D1)

ethylene copolymer composed of

59.8% by weight of ethylene

4.5% by weight of acrylic acid

35% by weight of n-butyl acrylate

0.7% by weight of maleic anhydride

### Component D2)

glass fibers (OCF 123 D 10 P)

### Component D3)

ZnO—zinc oxide

The molding compositions were prepared in a ZSK 40 with throughput of 30 kg/h and a flat temperature profile at about 290° C.

The following tests were carried out:

Tensile test to ISO 527-2, and also
Charpy notched impact resistance to ISO 179/1eU, glow-wire test to IEC 60 335 on the “BASF L10” component.

Side/rear: Different orientation of test on component. In each case, the number of tests passed is stated, from 10 tests carried out. The modulus of elasticity, tensile stress at break, tensile strain at break, and Charpy impact resistance tests were carried out on dry test specimens (dry as molded).

The constitutions of the molding compositions and the results of the tests are given in the table.

| Components | | | | | | |
|---|---|---|---|---|---|---|
| in [% by | | | | | | |
| weight] | 1 C | 2 C | 3 C | 1 | 2 | 3 |
| A | 63.3 | 64.3 | 69.3 | 65.3 | 57.8 | 51.8 |
| B | — | — | — | 4 | 4 | 4 |
| Ca | 5 | 4 | 5 | 5 | — | — |
| Cb | | | — | | 12.5 | 12.5 |
| D1 | 6 | 6 | — | — | — | 6 |
| D2 | 25 | 25 | 25 | 25 | 25 | 25 |
| D3 | 0.7 | 0.7 | 0.7 | 0.7 | 0.7 | 0.7 |

| GWT 750 < 2s | | Comp. 1 | Comp. 2 | Comp. 3 | Inv. Ex. 1 | Inv. Ex. 2 | Inv. Ex. 3 |
|---|---|---|---|---|---|---|---|
| on component | side | (4/10) | (2/10) | (2/10) | (6/10) | (8/10) | (10/10) |
| “BASF L10” | rear | (4/10) | (3/10) | (4/10) | (7/10) | (10/10) | (10/10) |
| Modulus of | MPa | 11000 | 10500 | 11200 | 12000 | 11552 | 11536 |
| elasticity | | | | | | | |
| ISO 527-2 | | | | | | | |
| Tensile stress | MPa | 160 | 155 | 172 | 170 | 169 | 168 |
| at break | | | | | | | |
| ISO 527-2 | | | | | | | |
| Tensile strain | % | 3 | 2.6 | 2.7 | 2.1 | 2.3 | 2.4 |
| at break | | | | | | | |
| ISO 527-2 | | | | | | | |
| Charpy | kJ/m² | 70 | 69 | 65 | 61 | 67 | 65 |
| ISO 179/1eU | | | | | | | |

1-8. (canceled)

9. A thermoplastic molding composition, comprising
a. from 20 to 98% by weight of at least one thermoplastic polyamide
b. from 0.5 to 10% by weight of a melamine compound
c. from 0.5 to 40% by weight of red phosphorus
D1) from 1 to 40% by weight of an impact modifier based on an ethylene polymer which comprises acid groups or anhydride groups as functional monomers and
D2) from 0 to 50% by weight of additional additives,
where the total of the percentages by weight of A) to D) is 100%.

10. The thermoplastic molding composition according to claim 9, where component C) is used in the form of a concentrate (masterbatch) in a polyamide.

11. The thermoplastic molding composition according to claim 10, where the constitution of the masterbatch is:
C₁) from 30 to 90% by weight of polyamide
C₂) from 10 to 70% by weight of red phosphorus.

12. The thermoplastic molding composition according to claim 9, wherein component B) is composed of melamine polyphosphate.

13. The thermoplastic molding composition according to claim 11, wherein component B) is composed of melamine polyphosphate.

14. The thermoplastic molding composition according to claim 9, wherein the polyamide has a viscosity number of from 90 to 350 ml/g, determined in a 0.5% strength by weight solution in 96% strength by weight sulfuric acid at 25° C. to ISO 307.

15. The thermoplastic molding composition according to claim 9, wherein the polyamide has a viscosity number of from 110 to 240 ml/g, determined in a 0.5% strength by weight solution in 96% strength by weight sulfuric acid at 25° C. to ISO 307.

16. The thermoplastic molding composition according to claim 9, wherein the polyamide is polyhexamethyleneadipamide, polyhexamethylenesebacamide, polycaprolactam, or nylon-6/6,6 copolyamide.

17. The thermoplastic molding composition according to claim 13, wherein the polyamide is polyhexamethyleneadipamide, polyhexamethylenesebacamide, polycaprolactam, or nylon-6/6,6 copolyamide

18. The thermoplastic molding composition according to claim 11, comprising
a. from 20 to 95% by weight of at least one thermoplastic polyamide
b. from 1 to 8% by weight of a melamine compound
c. from 0.5 to 40% by weight of red phosphorus which comprises
C₁) from 50 to 70% by weight of polyamide and
C₂) from 30 to 50% by weight of red phosphorus.
D1) from 1 to 40% by weight of an impact modifier based on an ethylene polymer which comprises acid groups or anhydride groups as functional monomers and
D2) from 0 to 50% by weight of additional additives,
where the total of the percentages by weight of A) to D) is 100%.

19. The thermoplastic molding composition according to claim 17, comprising
a. from 20 to 95% by weight of at least one thermoplastic polyamide
b. from 1 to 8% by weight of a melamine compound
c. from 0.5 to 40% by weight of red phosphorus which comprises
C₁) from 50 to 70% by weight of polyamide and
C₂) from 30 to 50% by weight of red phosphorus.
D1) from 1 to 40% by weight of an impact modifier based on an ethylene polymer which comprises acid groups or anhydride groups as functional monomers and
D2) from 0 to 50% by weight of additional additives,
where the total of the percentages by weight of A) to D) is 100%.

20. A fiber, a foil, or a molding which comprises the thermoplastic molding compositions according to claim 9.
